(19) United States
(12) Patent Application Publication
(10) Pub. No.: US 2002/0007300 A1
(43) Pub. Date: Jan. 17, 2002

(54) Device and method for organizing and presenting worker tasks in a network-based portal environment

(76) Inventor: Michael Slatter, Park City, UT (US)

Correspondence Address: HOLLAND & HART LLP, PO BOX 8749, 555 17TH STREET, STE 3200, DENVER, CO, 80201, US

(21) Appl. No.: 09/880,674

(22) Filed: Jun. 13, 2001

Related U.S. Application Data
(60) Provisional application No. 60/211,426, filed on Jun. 14, 2000.

(51) Int. Cl. G06F 17/60

(52) U.S. Cl. 705/9

(57) ABSTRACT

The present invention provides systems for generating and presenting tasks to at least one user include a workflow template memory that stores at least one workflow template. The workflow template identifies at least one task for the at least one user to complete. A workflow management component uses the workflow template to assign the at least one task to the at least one user. A graphical-user-interface at a client device associated with the at least one user displays the assigned task in a task field. When the at least one user selects the assigned task, a program connecting device provides the at least one user access to at least one of tools, information, and applications necessary for the at least one user to complete the assigned task.

### RELATED APPLICATIONS

This application claims priority from U.S. Provisional Patent Application No. 60/211,426, filed Jun. 14, 2000, titled ePlant.management.

### TECHNICAL FIELD OF THE INVENTION

This invention relates to network-based portal environments and, more particularly, to the integration of such environments with workflow, document management, and other software components in a transparent manner for a seamless presentation of worker tasks to a user as well as seamless connection to information, tools, and applications necessary for the user to perform the presented task.

### BACKGROUND OF THE INVENTION

Task or “to-do” lists are common in today's working environment. Traditionally, such lists were kept on paper, and updated by hand. In more advanced working environments, electronic lists have replaced paper lists. The more advanced electronic lists include those found in the various commercially available calendaring and e-mail packages, including Novell's Groupwise® and Microsoft's Outlook®.

There are several problems with such conventional task lists. In less advanced systems, users or workers identify and place tasks on the list that require the attention of the user. These less advanced systems have several drawbacks. First, the tasks have to be updated by hand when the user completes the task. Second, the user needs to “roll over” any uncompleted tasks to the task list for the next day by hand. Third, these task lists are little more than reminders, and typically, they do not provide the applications or the information to complete the task. Obviously, the less advanced task list system is prone to human error.

More advanced task list systems, such as the e-mail and calendaring systems mentioned above, solved some of the deficiencies of the manual system. For example, many of the calendaring programs provide for tasks to roll over from day to day until completed. Some of these programs also allow users to record information associated with the tasks. Finally, authorized users can frequently access other workers task lists and insert specific tasks to other worker's task lists. While these are partial solutions to deficiencies of the less advanced systems, the electronic systems were little more than simple reminder lists in themselves. In any event, the systems still did not provide connections to required tools, information, and applications needed by the users to complete the presented tasks.

Accordingly, there is a need in the art for a device and method for pushing tasks to users in such a way that they become a natural extension of the users' work process. This is done in a network-based portal environment by transparently providing applications and information linked to the task to allow the user to efficiently perform their work.

### SUMMARY OF THE INVENTION

To attain the advantages of and in accordance with the purpose of the present invention, as embodied and broadly described herein, systems for generating and presenting tasks to at least one user include a workflow template memory that stores at least one workflow template. The workflow template identifies at least one task for the at least one user to complete. A workflow management component uses the workflow template to assign the at least one task to the at least one user. A graphical-user-interface at a client device associated with the at least one user displays the assigned task in a task field. When the at least one user selects the assigned task, a program connecting device provides the at least one user access to at least one of tools, information, and applications necessary for the at least one user to complete the assigned task.

Other embodiments of the present invention provide methods for generating and presenting tasks to at least one user. These methods include storing at least one workflow template that identifies at least one task for at least one user to complete. Assigning the at least one identified task to the at least one user. The assigned task is displayed on a graphical-user-interface at a client device associated with the at least one user. Monitoring the task to identify a status of the task and updating the status as necessary. The at least one user selects the at least one task from the graphical-user-interface to provide access to at least one of tools, information, and applications.

Still other embodiments of the present invention provide computer program products having computer readable code for processing data to generating and presenting tasks to at least one user. The computer program product includes a workflow template module that is configured to store at least one workflow template that identifies at least one task for at least one user to complete. A workflow management component is configured to use the workflow template stored in the workflow template module to assign the at least one task to at least one user. A display module is configured to display the at least one assigned task at a graphical-user-interface on a client device associated with the at least one user. On selecting the task, a program connecting module provides access to the at least one user to tool, information, and application necessary to complete the task.

The foregoing and other features, utilities and advantages of the invention will be apparent from the following more particular description of a preferred embodiment of the invention as illustrated in the accompanying drawings.

### BRIEF DESCRIPTION OF THE FIGURES

The accompanying drawings, which are incorporated in and constitute a part of this specification, illustrate embodiments of the present invention, and together with the description, serve to explain the principles thereof. When possible, like items in the drawings are referred to using the same numerical reference.

FIG. 1 is a block diagram of a system in accordance with this invention for organizing and presenting worker tasks in a network-based environment;

FIG. 2 is a block diagram illustrating a system architecture organized in accordance with an embodiment of the present invention;

FIG. 3 is a representation of one possible graphical user interface in accordance with the present invention;

FIG. 4 is a functional block diagram of a possible knowledge management component in accordance with the present invention;

FIG. 5 is a graphical user interface for a possible knowledge management component in accordance with the present invention;

FIG. 6 is a flowchart exemplifying a possible workflow management component in accordance with the present invention;

FIG. 7 is a graphical user interface associated with a Management of Change application in accordance with the present invention; and

FIG. 8 is a graphical user interface associated with a blend application in accordance with the present invention.

### DETAILED DESCRIPTION

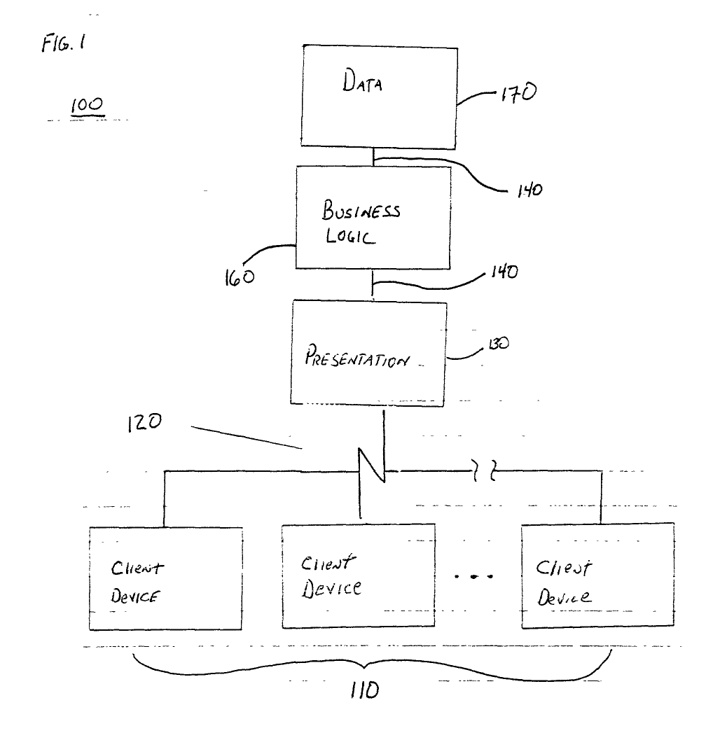

Some embodiments of the present invention are shown in FIGS. 1-8. On reading the disclosure contained herein, other embodiments of the present invention will be apparent to those of ordinary skill in the art. For example, the present invention is described using web-based components and applications having separate client and server locations. One of skill in the art, however, would recognize the present invention system could use other architectures, such as various local area networks, wide area networks, wireless networks, or even other Internet protocols.

FIG. 1 shows an operating network configuration 100 for the present invention. Configuration 100 could be accessed through a local area network, a wide area network, an intranet configuration, a World Wide Web configuration, or a wireless network configuration. In particular and as is well know in the art, configuration 100 includes a plurality of client devices 110 connected via a network 120, which is preferably an intranet or Internet connection, to a presentation server 130, a business logic server 160, and data server 170, by means of a physical network connection 140 across multiple servers or logical connection if on a single server. These servers may be hosted remotely through an Application Service Provider (ASP) data center. It is presently preferred to use Sun Microsystems, Inc.'s Solaris™ or Microsoft Windows NT® operating system including compatible web servers, application servers, database memories and client devices 110. The client devices 110 could be monitors connected to the network, but preferably, the client devices 110 are personal computer style client devices. As used in this application, however, client device broadly refers to personal computers, wireless devices, handheld computing devices, PDA, and other computing devices capable of displaying information to a user. Each client device 110 includes browser software such as Microsoft, Inc.'s Internet Explorer or Netscape's browser Netscape Navigator. Moreover, it is presently preferred to support applications using Java based programming, and more particularly, the J2EE specification currently available from Sun Microsystems, Inc. of Mountain View California.

### SYSTEM INFRASTRUCTURE OVERVIEW

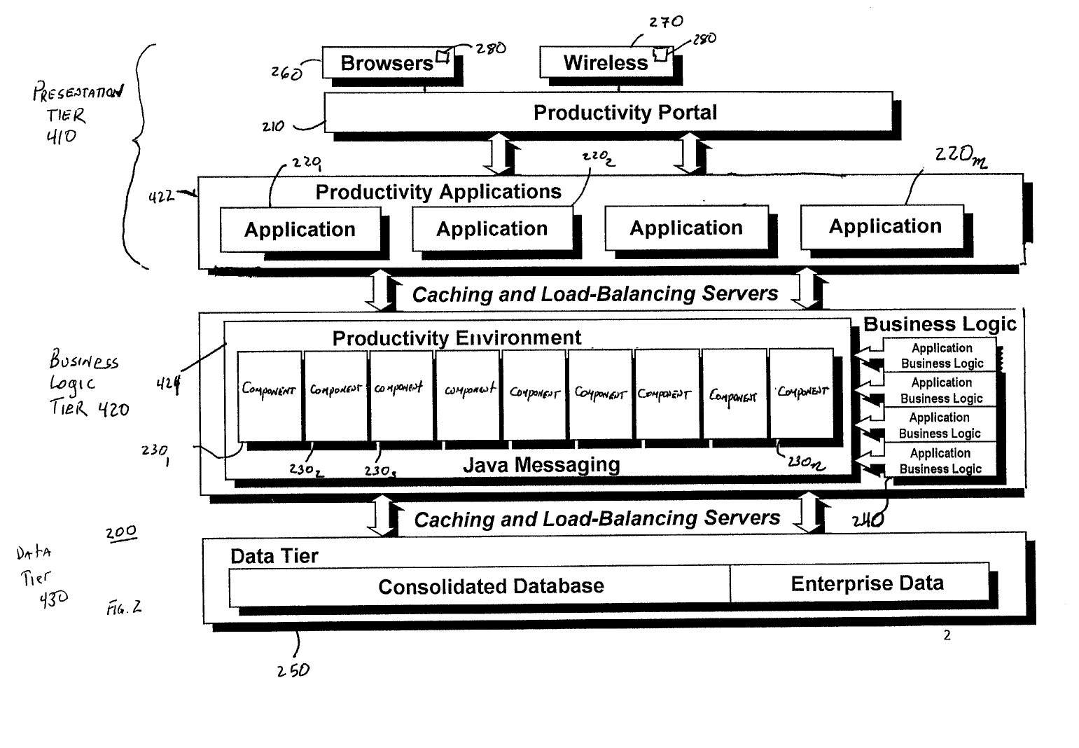

FIG. 2 shows a system architecture 200 in accordance with the present invention. In this example, the present invention is installed in a gasoline refinery plant management system. As one of skill in the art will recognize on reading this disclosure; however, while some of the applications described below are specific for gasoline refinery plant, the present invention could be employed in any number of plants, organizations, or management systems. Generally, different types of plants, organizations, and management systems will contain the same system infrastructure, but will contain different domain specific applications and domain specific components, as will be explained further below.

Each functional portion of system architecture 200 could be performed on a single or multiple servers as a matter of design choice. Architecture 200 includes a portal 210, a number of domain specific applications 220ₗ to 220ₘ (the example shows four domain specific applications; however, more or less are possible), a number of domain specific components 230ₗ to 230ₙ (the number and type of components is dependent on the interaction needed between the domain specific application and the ultimate users), at least one application business logic module 240, and a database memory 250. Domain specific applications could be, for example, a Management of Change (MOC) application, a blender application, an asset reallocation application, or an equipment replacement application (which applications will be explained further below). Domain specific components could be, for example, a knowledge management component, a security component, and a workflow management component (which will be explained further below in conjunction with the domain specific applications).

As mentioned above, system architecture 200 shows only a single server; however, the architecture could be a plurality of interconnected servers. The server(s) contain programs, software, and hardware necessary to run the various domain specific applications and components.

Also, as shown in FIG. 2, portal 210 connects to the user through a thin-client presentation within a browser 260 located on a client device, such as client devices 110 or wireless device 270. Further, as shown but not specifically labeled or explained, system architecture 200 can provide caching and load-balancing functions between functional portions of system architecture 200.

Portal 210 provides an interface between the system architecture 200 and, for example, client devices 110 operated by users. The portal 210 allows a remote or local user of system architecture 200 to interact with the system architecture 200 using a graphical user interface (GUI), which will be explained in more detail below.

### THE n-TIER ARCHITECTURE

FIG. 2 shows one embodiment of system architecture 200 capable of implementing the system described above. The architecture shown in FIG. 2 illustrates a n-tier architecture. System architecture 200 illustrates the use of three (3) tiers, however, more or less tiers are possible. As shown in FIG. 2, system architecture 200 has a presentation tier 410, a business logic tier 420, and a data tier 430. This architecture could be supported using systems such as Sun Microsystems, Inc.'s Solaris™ or Microsoft, Inc.'s Microsoft NT™.

Presentation tier 410 includes the browser 260 located at a client device, such as at user client devices 110, which could be a monitor, personal computer, or other network compatible client devices. Alternatively, the client device could be a wireless device 270, or a combination of browsers 260 on client devices 110 and wireless devices 270. Typically, a client locates presentation tier 410 at the client/user site. Browser 260, or wireless device 270, has a GUI 280 that allows a user to interface with system architecture 200 through portal 210. Section 422 provides a user presentation of domain specific applications 220. As is implied from the name, presentation tier 410 presents information to the user.

Business logic tier 420 can include at least one separate server (not specifically shown). Alternatively, the business logic tier server could be multiple servers, which could be clustered to provided installed redundancy. When multiple servers are used, a load director located between the servers can be used to provide load balancing (not specifically labeled or explained in FIG. 2 for simplicity). For example, the load director sends user requests to the server being used the least and is capable of performing the requested operation, although other loading protocols are possible. FIG. 2 shows business logic tier 420 includes, for example, an application level section 240 and a component level section 424 of system architecture 200. Applications, such as the MOC application, the blender application, and the asset reallocation application; and components, such as a workflow management component and knowledge management component, are distributed as a matter of design choice. Business logic tier 420 uses application business logic modules 240 to perform data manipulation. The information generated on business logic tier 420 is transmitted to the user on presentation tier 410 through portal 210, browser 260 or wireless device 270, and GUI 280.

Finally, in this example, data tier 430 provides a comprehensive and integrated database memory 250. Database memory 250 could be, for example, a consolidated database and an enterprise database on a server compatible with running and maintaining an Oracle database or some other memory structure.

### THE USER INTERFACE

The Portal

With reference to FIG. 2, portal 210 will be described in more detail. Portal 210 includes an interface portion, not shown in FIG. 2, (the interface portion is located in the business logic tier 420 and transmits and receives information between the business logic tier 420 and the presentation tier 410) and a display portion, which could be a GUI 280 displayed through browser 260 or a GUI 280 displayed through a wireless device 270. Portal 210 displays the GUI 280 on display portion to provide a user interface. The interface portion of portal 210, GUI 280, and the business logic tier 420, which will be explained further below, are connected using a two-way communication system. The two-way communication system can be any conventional communication protocol, such as standard Internet protocols (IP), standard telephony protocols (such as ISDN), or wireless protocols (such as Bluetooth). Basically, portal 210 communicates information input at GUI 280 to the business logic tier and communicates, or allows access programs on the business logic tier and data on the data tier that are available to the user of the GUI 280.

The Graphical-User-Interface

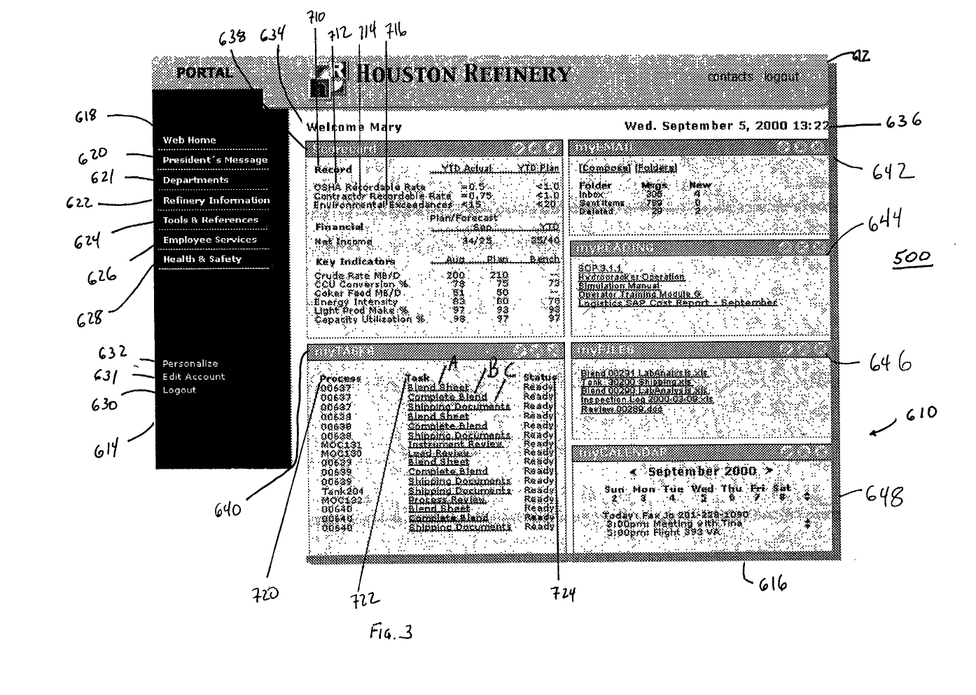

FIG. 3 shows a GUI 500, which is one possible GUI 280, in more detail. While GUI 500 is shown using one window to display the information, the fields and information could be displayed in more than one window or frame as a matter of design choice. All the graphical user interfaces described in this specification are exemplary and the arrangement of the GUIs and the type of information displayed is largely a combination of design choice and user responsibilities. GUI 500 can be displayed using a conventional web based html protocol with a standard framed window format including a window frame 610 having a top banner 612, which typically identifies the user's employer (but could be any type of banner as a matter of design choice), a side banner 614, which typically will include both mandatory and discretionary connections to, for example, other windows of the GUI, other web pages (both extranet and intranet pages), applications and information necessary for the user to perform particular functions, and a window portion 616 (which will be explained in more detail below). Window portion 616 could be blank until a particular user performs a login function. Side banner 614 could have mandatory connections to, for example, a tools and references page 624 as well as discretionary connections to, for example, an employer home page 618, a president's message page 620, a refinery information page 622, an employee service page 626, a health and safety page 628, and a departments page 621. Further, side banner 614 could have mandatory connections to, for example, a login/logout function 630 and a tailor or personalize GUI function 632. It is preferred to tailor the GUI connections for particular users/employees. Notice, login/logout function 630 currently indicates only a logout function because “Mary” has already logged in. By tailoring the connections, a particular user will only have connections to those pages, components, information, tools, or applications that user needs to perform the user's job. While FIG. 3 shows an edit account function 631, this function may be reserved for high-level users, such as system administrators. As one of ordinary skill in the art would recognize on reading this disclosure, the connections and whether the connections are mandatory or discretionary on the user's GUI is largely a function of design choice and user responsibilities.

As shown in FIG. 3, window portion 616 can have a user identification block 634, which in this case is “Welcome Mary” indicating the user is Mary, a date and time filed 636, which in this case is Wed. Sep. 5, 2000 13:22, a scorecard field 638, a Tasks field 640, an Email field 642, a Reading field 644, a Files field 646, and a Calendar field 648, each of which will be explained in more detail below. Other fields could be placed on the window, or the identified fields completely or partially removed.

Scorecard field 638 records and measures plant goals for the employee logged in to provide a monitoring function, similar to a batting average for a baseball player. Scorecard field 638 could be displayed for individuals, such as, for example, only Mary, but normally the same scorecard field 638 is displayed to a number of individuals having similar groupings, responsibilities, and roles. For example, if Mary was one of several shift managers, the scorecard field 638 would be the same for each of the other shift managers.

In particular, scorecard field 638 has at least one record field 710. The present example shows a record field 712 for OSHA recordable rate for employees, a record field 714 OSHA recordable rate for contractors 714, and a record field 716 for environmental exceedances field. Each field shows how many times that type of incident actually occurred as well as the budgeted number of occurrences. For example, as shown in field 712, the actual OSHA recordable rate for employees is 0.5 against a budgeted OSHA recordable rate of less than 1. OSHA recordables could be, for example, the number of safety violations per number of man-hours worked on a plant wide basis. Therefore, as this scorecard shows the actual recordable rate is less than one recordable, which is currently indicated as being the goal. As can be seen, the scorecard also shows financial information and key indicators for which users in Mary's group, for example, may be responsible.

Task field 640, called myTasks to indicate it is specific to Mary, is a list of processes assigned to Mary, which will be explained further in conjunction with the description of the workflow management component. For example, task field 640 has a process column 720, a task column 722, and a status column 724. Process column 720 typically is a tracking number associated with a process. For example, process 00637 in task field 640 has at least three items Mary needs to complete, tasks A, B, and C. For Task A, Mary must fill out a blend sheet. For Task B, Mary must complete the blend. For Task C, Mary must prepare shipping documents. Since there is a need in the art for pushing tasks to users in such a way that they become a natural extension of the users' work process, each task, such as Task A, B, and C, provides a connection to a new screen or new window on GUI 500 thereby transparently providing applications and information linked to the task to allow the user to efficiently perform their work.

As shown in status column 724, each task Mary must perform for process 00637 is in the ready state indicating task can be performed now. Other indicators could also be used, such as waiting, done, standby, not ready, in process, etc. For example, if Mary needed to fill out the blend sheet before she could complete the blend, the complete blend task would indicate, standby or waiting instead of ready until Mary filled out the blend sheet, at which time the status would be updated to ready. Also, while Mary was completing the blend sheet, the task status may indicate in process.

Unlike conventional task or to-do lists, task field 640 lists tasks and provides a program connection to the domain specific applications, tools, or information to perform the listed task. Part of connecting to, for example, the domain specific application, could include automatically logging into the particular application (which login, for example, may carry over from the login function from the portal application), or forcing the user to transmit a password to log into the application. For example, if Mary clicked on the blend sheet task in the task field, the knowledge management component (not shown, and described further below) would retrieve from a database memory in data tier 430 the blend sheet document currently stored. The request would also cause the business logic tier 420 to connect Mary to a blend sheet application, which could be a word processing program, such as Microsoft Word displayable on Mary's GUI. Mary would then fill out the blend sheet for process 00637, task A. If the blend sheet document was a secure document, knowledge management component, or some other component assigned the security function in system architecture 200, could retrieve Mary's user name or password from the a login component, not specifically described, for automatic logging in, or it could display a password prompt on her GUI requesting Mary to enter her password. In other words, Mary is connected to the applications, documentation, and information necessary to perform the task listed when the task is selected by Mary.

Once Mary completed the blend sheet task, if, for example, Joseph needed to review the completed blend sheet, process 00637 would show on Joseph's portal GUI a task D (not shown), which task would indicate “review the blend sheet” and the status column would indicate “Ready,” because Mary has completed the blend sheet. When Joseph clicked on the task D in his GUI, he would be connected to the completed blend sheet allowing him to complete the review task. Again, the automatic or manual login could be required.

Email field 642 monitors Email accounts. The user can edit this field to track the Email information the user desires. For example, the Email field 644 tracks total messages and new messages. Reading field 646 lists articles the user may subscribe to or required reading for the particular job the user performs. Supervisors may insert articles or required reading into an employees reading list. Also, articles or subscriptions could be automatically inserted by the system as they become available. Clicking on the article displays the article on the users monitor and launches any necessary applications to allow the document to be viewed, such as Adobe Acrobat®.

As one of ordinary skill in the art would recognize on reading this disclosure, task field 640, as well as any of the fields, could be arranged to display all tasks the user is responsible for, tasks needed to be completed on a particular day, tasks related to a particular type of project (for example blends). What types of fields and actual field content is largely a matter of design choice.

### DOMAIN SPECIFIC COMPONENT EXAMPLES

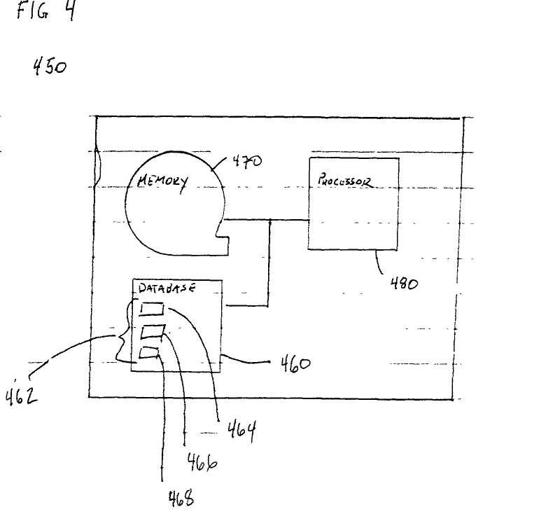

FIGS. 4-6 illustrate two common components that may be associated with the infrastructure described above, with respect to FIG. 2. Particular components would be dependent on the interaction that would be needed between the users and the domain specific applications. Types of domain specific components 230 include, among others, security components, database access components, knowledge management components, workflow management components, reporting components, searching components, etc. Moreover, domain specific components could be combined, such as the security functionality of the security component could be integrated into the knowledge management component, etc. Two typical components, the knowledge management component and the workflow management component, are described further below.

Knowledge Management Component

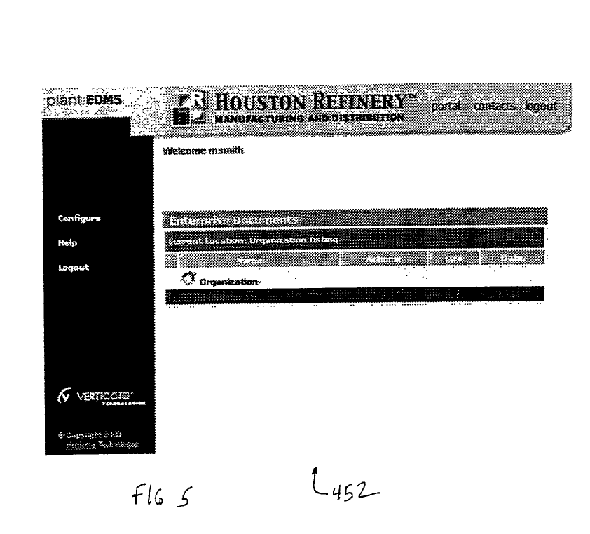

FIG. 4 shows a functional block diagram of one embodiment of a knowledge management component 450 in more detail. In particular, knowledge management component 450 includes a knowledge management and security database 460, a memory 470 and a knowledge management and security control processor 480. As one of skill in the art will recognize on reading the following disclosure, knowledge management component 450 allows management and security for a number of different applications and components, the below description is based on a file management system for simplicity, such as an iManage file management system by iManage, Inc. FIG. 5 illustrates one possible GUI 452 for knowledge management component 450.

Knowledge management and security database 460 has a plurality of fields 462 including a file management associate field 464, a file management director field 466, and a document ID field 468. Document ID field 468 identifies the location in memory 480 a particular document or file is stored as well as other pertinent information such as document version, historical access and editing information, etc. When an appropriate user requests that document identified by document ID field 468, processor 470 retrieves the document from memory 480.

File management associate field 464 and file management director field 466 include identification and information about various system users and the roles for which each user is associated. For example, file management director field 466 may indicate that Joseph is an administrator with authority to assign tasks. File management associate field 464 may have an entry for Mary. Because Joseph is identified in the director field 466, he is able to assign Mary, who is identified in the associate field 464, to a particular pool of people having predefined roles. In other words, Joseph may place Mary in the pool of people assigned to Role A. Memory 470 would store tasks for which Role A employees are responsible. Therefore, as will be explained further below, when the workflow management component identifies a task associated with a Role A person, processor 480 would identify in the associate field 464 users with a Role A grouping and assign the task to, in this case, Mary. This task would then appear in Mary's task field 640 on GUI 500, FIG. 3. Director fields typically includes system administrators for the plant capable of setting up new users, assigning users to pools having defined roles, assign security levels for access to folders, etc. Associate fields generally indicate those tasks for which the user/employee in any particular grouping is responsible. While only two levels, director and associate, are discussed above, more or less organizational levels could be provided by the system. Also, employees, such as, for example, Joseph, could be listed in multiple fields. In this example, Joseph could be listed in both the director fields and the associate fields. Also, the functional parts of the above knowledge management component 450 could be located on one or more servers, and in one or more memories or databases.

Workflow Management Component

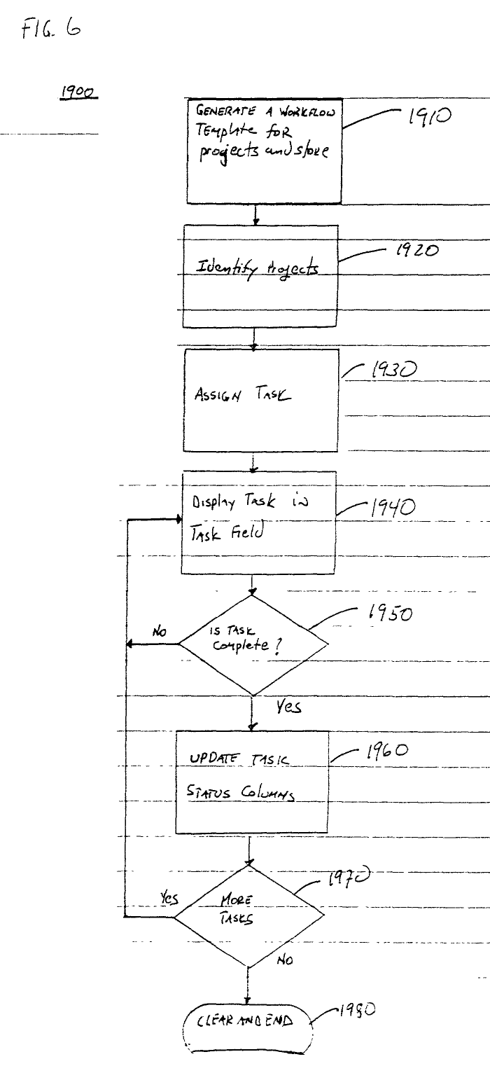

Workflow management component manages and assigns tasks. FIG. 6 is a flowchart 1900 describing the operation of one possible workflow management component. First, a system administrator generates a workflow template for projects to be performed and stores the template in a workflow template memory, step 1910. The workflow templates typically include specific tasks to complete a project, the user group responsible for that task (which would be identified in associate field 464), and the order in which the tasks must/should be performed. For example, if an equipment replacement application (one of the applications 220) indicated a temperature sensor needed to be replaced, a workflow template may have the following five (5) tasks: de-energize temperature sensor electrically, by-pass coolant, establish containment area, replace existing sensor with new sensor, and test. Each of these tasks may have tasks also. Preferably, these templates are predefined and stored before the project needs to be performed. Next, projects that need to be performed are identified, step 1920. After the project is identified, the workflow management component assigns tasks established by the template to users that are associated with a pool of employees responsible for the task, step 1930. For example, if one of group A's assignable tasks was de-energizing temperature sensors, then the workflow management component would assign the task of de-energizing the sensor to a user in group A as identified in the associate field 464. Task can be assigned based on groups, roles, responsibilities, training, status, etc. The workflow management component then displays the task and task status in the user's task field 640, step 1940. Once displayed, the workflow management component determines when the assigned user completes the task, step 1950. If the task is complete, the workflow management component updates the status of all the tasks that have been assigned, step 1960. For example, once the de-energize temperature sensor electrically task is complete, the user who was assigned the task of by-pass coolant, which is the next task and could not be performed until the previous task was complete, will have the task status column 724 updated to indicate “Ready,” or some other equivalent indication showing the assigned task can now be performed. Finally, the workflow management component determines whether additional tasks still need to be performed, step 1970. If more tasks need to be performed, the tasks continue to be displayed, step 1940. If no more tasks need to be performed, the tasks are complete and the tasks are removed from display, step 1980. Notice, the system could easily be modified to continue displaying completed tasks until the project is finished or delete tasks as they are performed. Because of the unique task management structure of the workflow management component 280, it is possible to design charts and logs of the project to monitor and evaluate the project as it progresses. For example, budgeted time to de-energize the sensor may be six hours from when the task is assigned. It would be possible to evaluate the actual to budgeted time and display the result in, for example, scorecard field 638.

### DOMAIN SPECIFIC APPLICATIONS

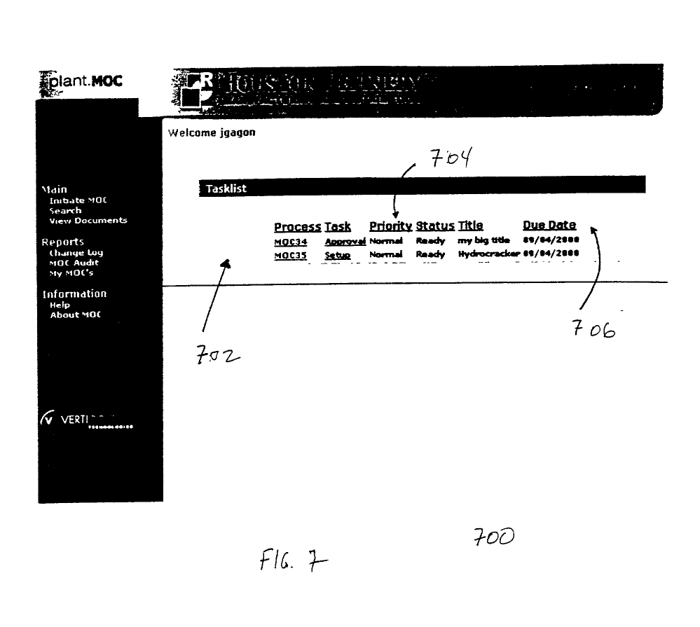

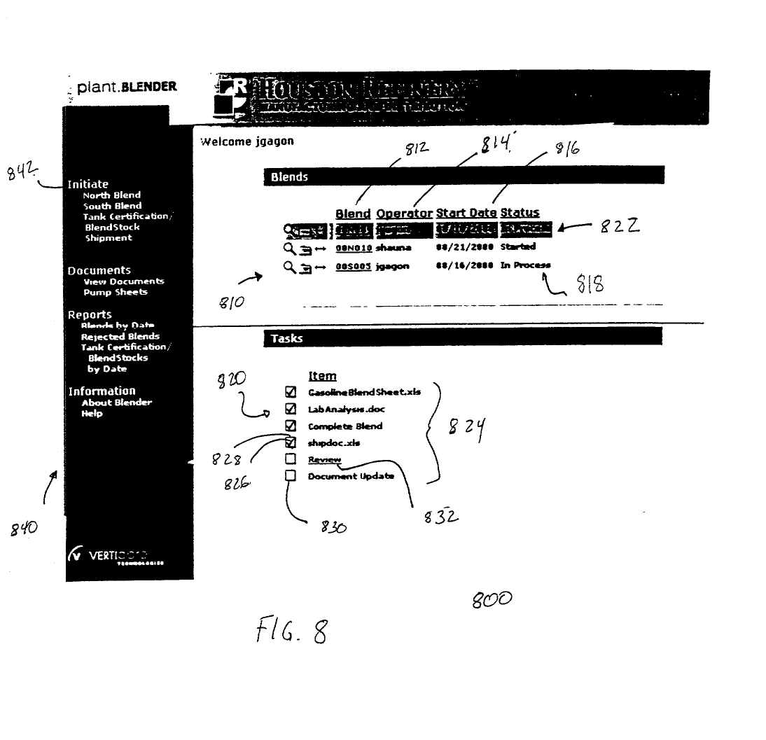

FIGS. 7 and 8 illustrate two possible domain specific applications components that may be associated with, for example, a refinery plant subject to OSHA guidelines. Other domain specific applications, such as the Asset Reallocation Application (not associated with a specific FIG), are dependent of the type of plant, organization, and/or management system being used. Types of domain specific applications are as varied as the types of plants, organizations, and management systems the above infrastructure could be combined with.

Management of Change Application

One type of Domain Specific Application 220 could be a Management of Change (MOC) Application. The MOC Application would be accessible by the workflow management component to assign and track tasks as is described above. In this case, MOC Application is based on OSHA PSM standard 1910. The OSHA PSM standard defines procedures, analysis, and tests to govern, monitor, and control changes to the plant (refinery plant in this case). Mostly, PSM standard 1910 relates to changing of physical objects (such as the temperature sensor generally described above in conjunction with flowchart 1900), but could also be used to change operating procedures, target application limits, safety parameters, etc. Presently, MOC application is separately described because it has generic application to a wide variety of plants (while a separate workflow management component could be used to interact with this MOC application, it is preferred to use one workflow management component and provide specialty workflow templates based on OSHA standards). In other words, the standard requires specific tasks that may not be otherwise required for other projects but are mandated by OSHA for safety related tasks. FIG. 7 shows a MOC application user interface 700. MOC application user interface 700 has a MOC task list field 702 that shows the tasks. Unlike the more generic task list associated with field 640, FIG. 6, MOC task list field 702 has a MOC task priority field 704 and a MOC task due date field 706. While these fields can be included in other task lists, they are generally not required.

The MOC application provides one example of how applications can interact with the seamless task presentation system. In certain industries, when a worker sees the need to change work processes or equipment, set procedures need to be followed to ensure process safety—a process mandated by the OSHA PSM 1910 requirement. In the system herein contemplated, the worker could initiate an MOC process from the portal interface (FIG. 6 by for example, using the tools and references program connection 624) and be required by the system to input certain required information such as change contemplated, basis for change, etc.

Upon submission of the required information to the system, a task would appear on the integrated task list of the plant's MOC coordinator, (field 640, FIG. 6) indicating the existence of a new MOC process within the plant. For example, if Mary is the MOC Coordinator, when the user above initiated an MOC process, the task appears in Mary's task field 640 under the task list 722. Upon selecting that task, the system presents to the coordinator the information concerning the MOC proposal, along with the ability to assign roles and responsibilities, insert required documentation to the work process, add information, etc. The work process then proceeds through the company according to the pattern set by the coordinator as contained in the workflow template, sometimes assigning tasks according to name, sometimes because of role, training, group membership, etc. until the process is termed complete according to company policy. As each worker receives a task relating to the process, the requisite task appears on their task list (See either FIG. 7 field 700 or FIG. 6 field 722), and, as in the case of the coordinator, when the worker selects the task, the necessary information and applications are presented to enable the worker to complete their assigned task.

Blender Application

Another type of domain specific application 220 that is applicable for the refinery plant example is a blender application. The blender application is designed to file, store, track, and audit federally mandated documentation associated with refinery gasoline blending. The specialty application is exemplary only, and one of skill in the art will now recognize that other specialty applications could be designed using this disclosure based on the plant type, the organization type, and/or management system.

Once again, the blender application is a special implementation demonstrating the interaction of the domain specific components, such as the workflow management component and knowledge management component, and the domain specific applications, such as in this case the blender application. As with the MOC application above, the blender application has certain standards and tasks that can be preset because of the federally mandated procedures.

The blender application is described with reference to blender application user interface 800, FIG. 8. Blender application user interface 800 has a blends field 810, a blender task field 820, and side banner field 840. Blends field 810 has a blend batch column 812, which identifies the blend batch number (tracking number), a blend operator column 814, which identifies the user assigned the task by the workflow management component in conjunction with the knowledge management component, a blend start date column 816, which indicates target or actual start dates, and a blend status column 818. Choosing a particular blend, such as the blend indicated in row 822, from blends field 820 activates blend task field 820. Blend task field 820 displays at least one task 824 identified by the workflow management component that the user needs to complete as part of federally mandated blend procedures. Typically, blend task field 820 lists the tasks 824 in the order they should be performed indicating task that are complete, such as a check 826 in a box 828, and the tasks that are not complete, such as the box 830 without a check. Tasks can be presented along with other tasks directly to the central task field on the GUI 500 (FIG. 6 field 722). Also, the blend task field 820 would indicate, such as by the use of underline 832, the next task to be performed (of course other indicators are equally possible). The side banner 840 has program connections to tools, information, and possible other domain specific applications necessary to perform the tasks identified in task field 820. For example, an initiate program connection 842 could retrieve and display a blend sheet that the user needs to file out to initiate the blend process for a new blend.

Asset Reallocation Application

Another example of a domain specific application 220 could be an Asset Reallocation Application. Asset Reallocation Applications could be used in, for example, a full-service brokerage house or other financial consulting firm.

Frequently, a full-service brokerage house or financial consulting firm will receive requests to re-allocate a portion of assets in an account under their control. This request often will trigger a series of events within the organization. First, the validity of the request needs to be verified by having a document with the correct electronic signature submitted to the system via a computer network. After the verification, it is common for simultaneous events to need to occur, all of which need to come to a successful conclusion before the transaction can be enabled.

One manifestation of this process would involve having the request sent to two different workers within the organization. The first worker would receive a task on their task list (FIG. 6 field 722) requiring the nature of the transaction to be compared with rules previously established for the account. When the first worker acquires the task, information is presented to the worker containing the nature of the desired transaction and a listing of the rules for the account from the knowledge management application. The ability to execute a judgment on the transaction's appropriateness is also presented to the worker who can either choose to accept or reject the transaction, or to delegate the decision to someone else in the system.

A second worker receives a task on their task list requiring the comparison of the intended transaction to accepted financial models that forecast the risk distribution change the transaction would incur. Upon selecting this task, the worker is presented with a financial application, such as Microsoft's Excel® spreadsheet, that manages the financial models along with information on the requested asset allocation change. The ability to execute a judgment on the transaction's appropriateness is also presented to the worker who can either choose to accept or reject the transaction, or to delegate the decision to someone else in the system.

If either of the simultaneous checks are rejected, the task is removed from the task list of the other worker and the process is returned to organization's customer service department. If both checks are successful, the process is forwarded to a user on the organization's trading floor for execution.

Although this invention has been described with reference to particular embodiments, such as a OSHA PSM 1910 regulated entity, a gasoline refinery plant, and a full service brokerage house, one of ordinary skill in the art will recognize the invention is not limited to these described embodiments. Rather, the invention is limited only by the appended claims, which include within their scope all equivalent devices and methods that operate according to the principles of the invention as described.

1. A system for generating and presenting tasks to at least one user, the system comprising:
at least one workflow template memory;
the at least one workflow template memory storing at least one workflow template for a project;
the at least one workflow template identifying at least one task for at least one user to complete;
at least one workflow management component;
the at least one workflow management component uses the at least one workflow template to assign the at least one task identified by the at least one workflow template to the at least one user;
at least one client device capable of being associated with the at least one user;
the at least one client device comprises at least one graphical-user-interface associated with the at least one user
the at least one graphical-user-interface comprising at least a task field;
the task field displays the at least one task assigned to the at least one user by the at least one workflow management component on the at least one graphical-user-interface; and
at least one program connecting device to provide the at least one user access to at least one of tools, information, and applications to perform the at least one assigned task.

2. The system according to claim 1, further comprising:
at least one project generator;
the at least one project generator compiles at least one project indicated by at least one device;
the at least one project generator identifies one workflow template from the at least one workflow template memory based on the at least one project indicated by the device and supplies the one workflow template to the workflow management component.

3. The system according to claim 1, further comprising:
a task management device;
the task management device monitors a status of the at least one task and displays the status on the at least one graphical-user-interface.

4. A system according to claim 1, further comprising:
a task directing device;
the task directing devices causes the assignment of the at least one task to the at least one user based on at least one of role, responsibility, and group membership.

5. The system according to claim 3, wherein:
the task management device manages the flow of the at least one task from the at least one user to at least one other user when the at least one user completes the at least one tasks.

6. The system according to claim 1, comprising:
an assignment database, and
the assignment database identifies tasks that are to be performed by each user.

7. The system according to claim 6, wherein:
the workflow management component uses the assignment database to identify the at least one user to perform the at least one task.

8. A method performed on a processor for generating and presenting tasks to at least one user, the method comprising:
storing at least one workflow template that identifies at least one task to be completed by at least one user;
assigning the at least one identified task to the at least one user;
displaying the at least one assigned task to the at least one user on at least one graphical-user-interface displayed on at least one client device associated with the at least one user;
monitoring the at least one assigned task to identify at least one status of the at least one assigned tasks;
updating the status of the at least one assigned task;
selecting the at least one assigned task from the graphical-user-interface; and
accessing at least one application to perform the selected task at the at least one client device of the at least one user.

9. The method according to claim 8 wherein:
the monitoring step identifies the status of the at least one assigned tasks as at least one of standby, ready, in progress, pending, waiting, and complete.

10. The method according to claim 8, wherein:
the displaying step includes deleting the at least one assigned task from the display when the at least one assigned task is identified as complete.

11. The method according to claim 8, wherein:
the status of the at least one assigned task depends on the status of at least one other task assigned to at least one other user.

12. The method according to claim 8, wherein:
the displaying step displays information necessary for the at least one user to perform the at least one assigned task.

13. The method according to claim 8, comprising the steps of:
providing tools to perform the at least one assigned task to the at least one client device of the at least one user.

14. The method according to claim 8, wherein:
the assigning step assigns the at least one task to the at least one user based on at least one of role, responsibilities, group membership, training, and status.

15. A computer program product comprising:
a computer usable medium including computer readable code embodied therein for processing data to generate and present at least one task to at least one user, the computer usable medium comprising:
a workflow template module configured to store at least one workflow template that identifies at least one task for at least one user to complete for at least one project;
a workflow management component configured to use the at least one workflow template to assign the at least one task to the at least one user; and
a display module configured to generate and display at least one graphical-user-interface comprising at least a task field; and
a program connecting module configured to provide access for the at least one user to at least one application required to perform the at least one assigned task.

16. The computer program product according to claim 15 further comprising:
a project generator module configured to compile at least one project; and
the project generator module configured to use the at least one project to indicate to the workflow management component that workflow template stored in the workflow template module that the workflow management component should use to assign the at least one tasks.

17. The computer program product according to clam 15, comprising:
a task management module configured to monitor a status of the assigned at least one task.

18. The computer program product according to claim 17 wherein:
the task management module is configured to identify the status as one of at least standby, ready, in progress, pending, waiting, and complete; and
the display module is configured to display the status.

19. The computer program product according to claim 15, comprising:
an assignment memory module configured to identify those tasks that are performed by each user.

20. The computer program product according to claim 15 further comprising:
a directing module configure to cause the workflow management component to assign the at least one task to the at least one user based on at least one of role, responsibilities, group membership, training, and status.
